(19) United States
(12) Patent Application Publication
(10) Pub. No.: US 2019/0318260 A1
(43) Pub. Date: Oct. 17, 2019

(54) RECORDING MEDIUM WITH MACHINE LEARNING PROGRAM RECORDED THEREIN, MACHINE LEARNING METHOD, AND INFORMATION PROCESSING APPARATUS

(71) Applicant: FUJITSU LIMITED, Kawasaki-shi (JP)

(72) Inventors: Suguru YASUTOMI, Kawasaki (JP); TAKASHI KATOH, Kawasaki (JP); Kento UEMURA, Kawasaki (JP)

(73) Assignee: FUJITSU LIMITED, Kawasaki-shi (JP)

(21) Appl. No.: 16/364,583

(22) Filed: Mar. 26, 2019

(30) Foreign Application Priority Data
Apr. 12, 2018 (JP) 2018-077055

(51) Int. Cl. G06N 20/00; G06F 17/15; G06F 17/14; G06N 3/08

(52) U.S. Cl. CPC G06N 20/00; G06N 3/08; G06F 17/14; G06F 17/15

(57) ABSTRACT

A non-transitory computer-readable recording medium with a machine learning program recorded therein for enabling a computer to perform processing includes: generating augmented data by data-augmenting at least some data of training data or at least some data of data input to a convolutional layer included in a learner, using a filter corresponding to a size depending on details of the processing of the convolutional layer or a filter corresponding to a size of an identification target for the learner; and learning the learner using the training data and the augmented data.

### CROSS-REFERENCE TO RELATED APPLICATION

This application is based upon and claims the benefit of priority of the prior Japanese Patent Application No. 2018-77055, filed on Apr. 12, 2018, the entire contents of which are incorporated herein by reference.

### FIELD

The embodiments relate to a recording medium with a machine learning program recorded therein, a machine learning method, and an information processing apparatus.

### BACKGROUND

According to a data augmentation technique for machine learning, noise is added to training data to augment the training data, and a learning process is carried out based on the augmented training data.

Related techniques are disclosed in Japanese Laid-open Patent Publication No. 06-348906, Japanese Laid-open Patent Publication No. 2017-059071, and Japanese Laid-open Patent Publication No. 2008-219825.

### SUMMARY

According to an aspect of the embodiments, a non-transitory computer-readable recording medium with a machine learning program recorded therein for enabling a computer to perform processing includes: generating augmented data by data-augmenting at least some data of training data or at least some data of data input to a convolutional layer included in a learner, using a filter corresponding to a size depending on details of the processing of the convolutional layer or a filter corresponding to a size of an identification target for the learner; and learning the learner using the training data and the augmented data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a configuration of a learning apparatus according to an embodiment;

FIG. 2 is a diagram illustrating an example in which independent Gaussian noise per element is added to input data;

FIG. 3 is a diagram illustrating an example of processing of a convolutional layer;

FIG. 4 is a diagram illustrating an example in which lightness and contrast of an overall image are changed;

FIG. 5 is a diagram illustrating an example in which spatially correlated noise is added to input data;

FIG. 6 is a diagram illustrating an example of addition of noise;

FIG. 7 is a diagram illustrating an example in which a parameter is selected depending on a size of an identification target;

FIG. 8 is a diagram illustrating an example in which a parameter is selected depending on a size of a sliding window on a convolutional layer;

FIG. 9 is a diagram illustrating an example of parameters and so on in a specific example;

FIG. 10 is a diagram illustrating an example of accuracies with respect to test data after a learning process in the specific example;

FIG. 11 is a flowchart illustrating an example of a learning process according to the embodiment; and

FIG. 12 is a diagram illustrating an example of a computer that executes a machine learning program.

### DESCRIPTION OF EMBODIMENTS

For data augmentation, for example, independent Gaussian noise per element of input data or intermediate layer output data is added to the input data. For example, if training data represent a natural image, data augmentation is performed by changing the lightness, contrast, and hue of the entire image.

If data augmentation based on data with independent Gaussian noise added thereto is applied to a convolutional neural network (CNN), for example, a pattern inherent in the Gaussian noise may be learned, resulting in a reduction in the accuracy of discrimination. Providing data input to the CNN represent a natural image, for example, when data augmentation is performed by changing the lightness, etc. of the entire image, it may be difficult to increase elements to be learned such as variations of the subject, thus making it difficult to increase the accuracy of discrimination.

There may be provided, for example, a machine learning process that increases the accuracy of discrimination by a learner including a convolutional process.

Embodiments of a machine learning program, a machine learning method, and a machine learning apparatus disclosed in the present application will hereinafter be described with reference to the drawings. The disclosed technology shall not be restricted by the present embodiments. The embodiments described below may be combined together appropriately insofar as the combinations are free of inconsistencies.

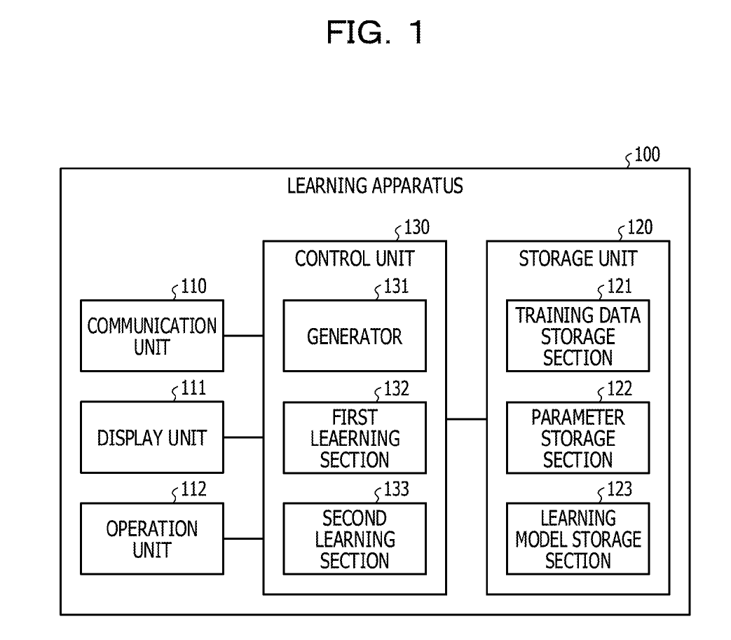

FIG. 1 is a block diagram illustrating an example of a configuration of a learning apparatus according to an embodiment. The learning apparatus, denoted by 100, illustrated in FIG. 1 represents an example of machine learning apparatus using a learner that includes a convolutional layer. The learning apparatus 100 generates augmented data that have been augmented using a filter having a size depending on the processing details of the convolutional layer, included in the learner, based on data of at least part of training data or at least part of data input to the convolutional layer. The learning apparatus 100 then performs a learning process for the learner, using the training data and the augmented data. The learning apparatus 100 is thus able to increase the accuracy of discrimination by learner that includes a convolutional process.

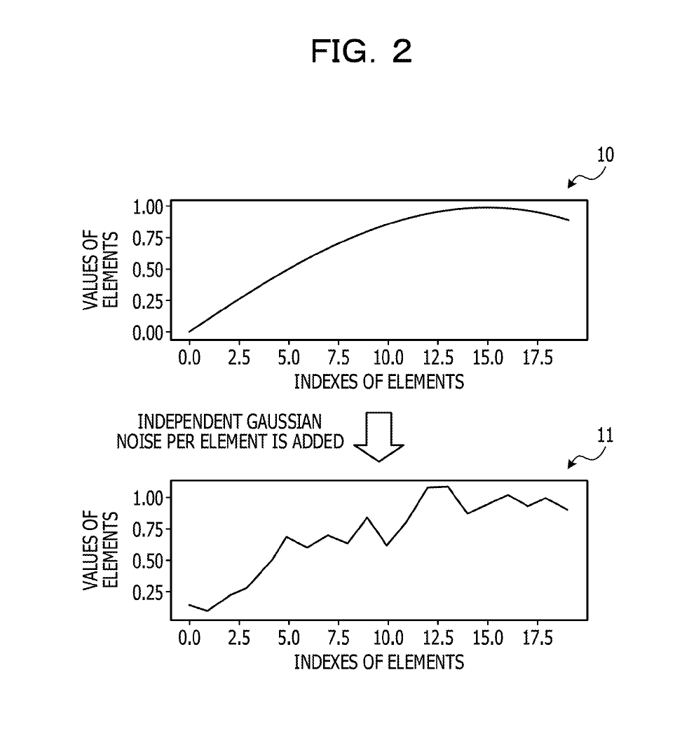

The addition of noise and the processing of the convolutional layer will first be described below with reference to FIGS. 2 through 4. FIG. 2 is a diagram illustrating an example in which independent Gaussian noise per element is added to input data. A graph 10 illustrated in FIG. 2 is a graph representing input data. When independent Gaussian noise per element is added to input data illustrated in the graph 10, the graph 10 is turned into a graph 11, for example. If the input data represent an image, independent Gaussian noise per pixel is added to the input data. Gaussian noise will also be referred to simply as “noise.”

The addition of independent Gaussian noise per element is less effective for a neural network including a convolutional layer. For example, since a CNN that is used for image recognition and object detection uses spatially continuous natural images as input data, the addition of independent Gaussian noise per element (pixel) is inappropriate as the augmented data deviate from data that are likely in reality. In learning convolutional layers, inasmuch as the texture of images is learned as features, a pattern inherent in Gaussian noise is learned, and the learning apparatus will not function unless Gaussian noise is also added also at the time of inference. For example, the addition of independent Gaussian noise per element results in learning an image where a grainy feature such as sandstorm, is superposed, like the graph 11, instead of the graph 10 that is a feature to be learned intrinsically.

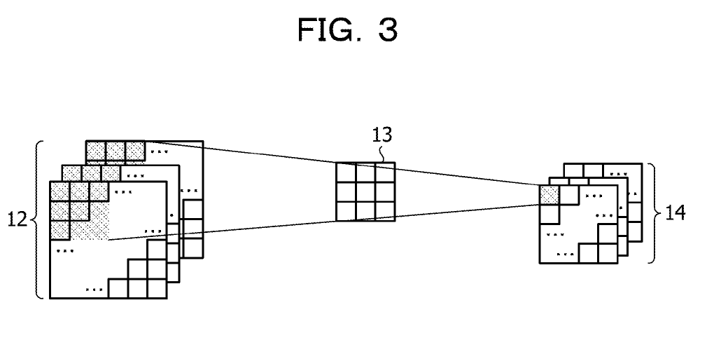

FIG. 3 is a diagram illustrating an example of a processing of a convolutional layer. In FIG. 3, a convolutional process is performed on an input image 12 using filters 13, producing an output image 14. In the example illustrated in FIG. 3, each channel of the input image 12 is individually convolved, and all of the convolved values are added into an element of the output image 14. At this time, the filters 13 of the convolutional process are determined by learning. The number of the filters 13 is determined by (the number of channels of the input image 12)×(the number of channels of the output image 14). In the convolutional layer, therefore, local features are learned in the range of the filters 13. For example, the relationship between adjacent pixels in the input image 12 is important. Therefore, the addition of independent Gaussian noise per element cause the learning apparatus to learn that adjacent elements are, for example, of necessity, different from each other in the range of noise, and to fail to learn continuous features of natural images which are to be learned intrinsically. In intermediate images, extracted boundaries tend to break by adding noise per pixel.

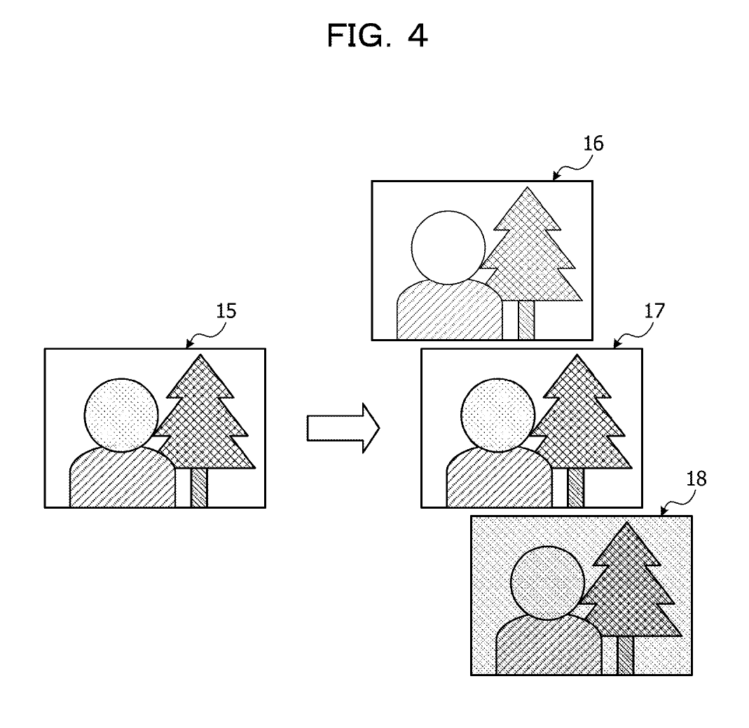

FIG. 4 is a diagram illustrating an example in which lightness and contrast of an overall image are changed. In the example illustrated in FIG. 4, input data 16 through 18 are obtained from input data 15 by changing the lightness, contrast, and hue thereof. The input data 16 through 18 represent variations of the overall image of the input data 15. Since variations such as clothes patterns and tree shades may not be generated, the accuracy may not be increased if such variations are a target to be recognized. For example, it is difficult in the example illustrated in FIG. 4 to generate data for dealing with small changes in the input data.

The makeup of the learning apparatus 100 will be described below. As illustrated in FIG. 1, the learning apparatus 100 includes a communication unit 110, a display unit 111, an operation unit 112, a storage unit 120, and a control unit 130. The learning apparatus 100 may further include various functional units that existing computers may include as well as the functional units illustrated in FIG. 1, for example, functional units such as various input devices, speech output devices, etc.

The communication unit 110 is implemented by a network interface card (NIC) or the like, for example. The communication unit 110 refers to a communication interface that is coupled through a wired or wireless link to another information processing apparatus via a network, not illustrated, and controls the delivery of information to and from the another information processing apparatus. The communication unit 110 receives training data to be learned and new data as a target to be discriminated from another terminal, for example. The communication unit 110 also sends learned results and discriminated results to other terminals.

The display unit 111 refers to a display device for displaying various items of information. The display unit 111 is implemented as such a display device by a liquid crystal display or the like, for example. The display unit 111 displays various screens such as display screens, etc. entered from the control unit 130.

The operation unit 112 refers to an input device for accepting various operations from the user of the learning apparatus 100. The operation unit 112 is implemented as such an input device by a keyboard, a mouse, etc. The operation unit 112 outputs operations entered by the user as operating information to the control unit 130. The operation unit 112 may be implemented as an input device by a touch panel or the like. The display device of the display unit 111 and the input device of the operation unit 112 may be integrally combined with each other.

The storage unit 120 is implemented by a semiconductor memory device such as a random access memory (RAM), a flash memory (Flash Memory), or the like, or a storage device such as a hard disk, an optical disk, or the like. The storage unit 120 includes a training data storage section 121, a parameter storage section 122, and a learning model storage section 123. The storage unit 120 stores information that is used in processing by the control unit 130.

The training data storage section 121 stores training data as a target to be learned that have been entered via the communication unit 110. The training data storage section 121 stores a group of data representing color images having a given size as training data.

The parameter storage section 122 stores various parameters of a learner and noise conversion parameters. The various parameters of the learner include initial parameters of convolutional layers and fully connected layers. The noise conversion parameters may be parameters of Gaussian filters or the like, for example.

The learning model storage section 123 stores a learning model that has learned training data and augmented data from data augmentation according to deep learning. The learning model stores various parameters (weighting coefficients), of a neural network, for example. For example, the learning model storage section 123 stores learned parameters of convolutional layers and fully connected layers.

The control unit 130 is implemented by a central processing unit (CPU), a micro processing unit (MPU), or the like, in which programs stored in an internal storage device thereof are executed using a RAM as a working area. The control unit 130 may alternatively be implemented by an integrated circuit such as an application specific integrated circuit (ASIC), a field programmable gate array (FPGA), or the like, for example.

The control unit 130 includes a generator 131, a first learning section 132, and a second learning section 133. The control unit 130 realizes or performs information processing functions or operations to be described below. The first learning section 132 and the second learning section 133 refer to learners of a CNN. The learners may be implemented as learning programs, for example, and may be rephrased as learning processes, learning functions, or the like. The first learning section 132 corresponds to a convolutional layer learning section, and the second learning section 133 corresponds to a fully connected layer learning section. The internal configuration of the control unit 130 is not limited to the configuration illustrated in FIG. 1, but may be of any of other configurations insofar as they perform information processing to be described later.

The generator 131 receives and acquires training data to be learned from a terminal such as an administrator's terminal via the communication unit 110, for example. The generator 131 stores the acquired training data in the training data storage section 121. The generator 131 refers to the training data storage section 121 and establishes noise conversion parameters based on the training data from the training data storage section 121. The generator 131 stores the established noise conversion parameters in the parameter storage section 122, and sets them to the first learning section 132 and the second learning section 133.

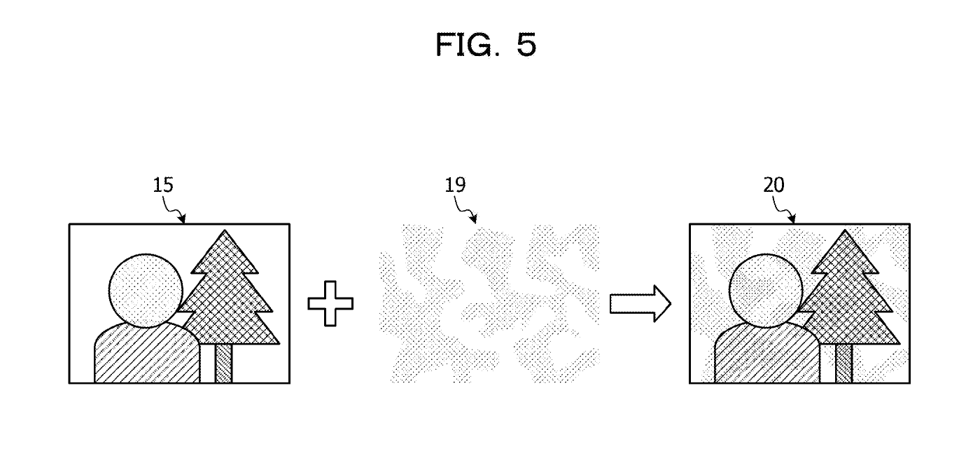

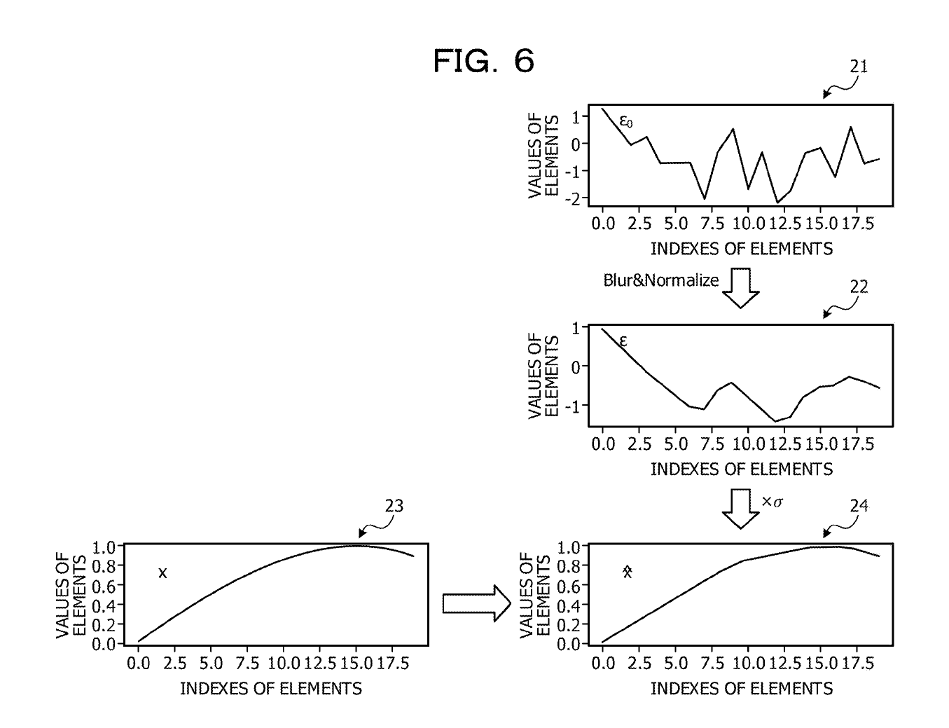

The addition of noise will be described below with reference to FIGS. 5 and 6. FIG. 5 is a diagram illustrating an example in which spatially correlated noise is added to input data. As illustrated in FIG. 5, the generator 131 adds noise 19 that has continuity as with natural images to input data 15, thereby generating augmented data 20. The noise 19 may be defined as spatially correlated noise, for example, blurred noise. Since the augmented data 20 represent an image that does not look unnatural as a natural image, the augmented data 20 are liable to make the data augmentation effective. The noise 19 does not adversely affect learning processes as it does not largely change the texture of the input data 15. For example, it is possible to generate variations in finer areas by adding the noise 19 compared with the generation of variations by changing the lightness and contrast of the entire image illustrated in FIG. 4.

FIG. 6 is a diagram illustrating an example of addition of noise. According to the example illustrated in FIG. 6, the generator 131 calculates noise ε by blurring and normalizing Gaussian noise ε₀ that is a standard normal distribution illustrated in a graph 21 according to the equation (1) illustrated below. A graph 22 illustrates the noise ε. The noise ε is generated for each channel as a target to which noise is to be added. Channels for training data representing a color image are three channels for RGB (Red, Green, Blue). Channels for an intermediate image output from an intermediate layer are about hundred through thousand channels depending on the configuration of the CNN.

ε=Normalize(Blur(ε₀)), where ε₀˜N(0,1),ε₀∈ [symbol] ^{W×H} (1)

Where Normalize(·) represents a function that normalizes noise to average 0 and variance 1, Blur(·) a function for spatially blurring noise, N(0,1) a standard normal distribution, and W, H a width and a height of an image to which noise is to be added or an intermediate image output from an intermediate layer of the CNN. Blur(·) may be realized by a convolutional Gaussian filter or an approximated convolutional Gaussian filter so that high-speed calculations may be achieved by a graphics processing unit (GPU) often used for deep neural network (DNN) learning. A convolutional Gaussian filter may be approximated by applying an average pooling process using a sliding window several times.

Next, the generator 131 adds the noise ε to data x illustrated in a graph 23, which is a target to which noise is to be added, according to the equation (2) illustrated below. In the equation (2), σ is a parameter representing the strength of noise. A graph 24 represents data to which the noise has been added.

\hat{x}=x+σε (2)

The generator 131 establishes a parameter (the variance of a Gaussian filter or the size of a sliding window) corresponding to the degree of a spatial blur, with respect to each noise adding process. The parameter corresponding to the degree of a spatial blur is an example of a noise conversion parameter.

There are roughly four noise adding processes. These processes will be referred to as processes (1) through (4) below. According to the process (1), the size of an object of interest in an image is determined in advance, and a parameter is established so that a spatial variance becomes about as large as the determined size. For example, according to the process (1), a parameter depending on the size of an identification target is selected.

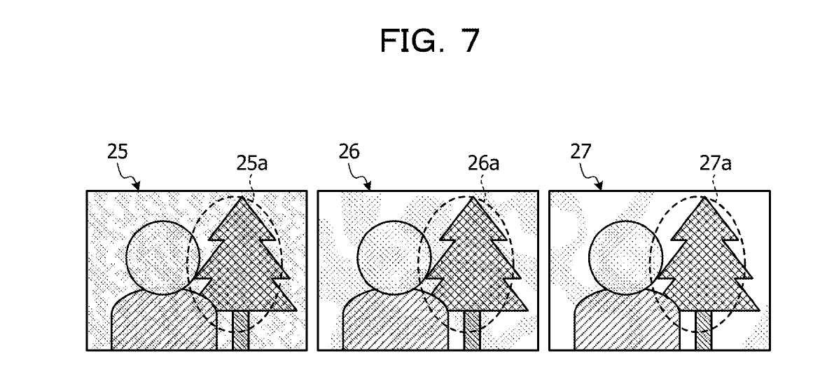

FIG. 7 is a diagram illustrating an example in which a parameter is selected depending on a size of an identification target. FIG. 7 illustrates an example of the process (1). According to the process (1), if the type of a tree is to be recognized based on its shade, for example, if an identification target is apparent, a parameter is selected such that the feature of the identification target varies. With respect to data 25 illustrated in FIG. 7, attention is directed to an area 25a that corresponds to a tree as an identification target. Since the degree of a blur of the tree in the area 25a is too detailed, no feature is left in the identification target. With respect to data 26, similarly attention is directed to an area 26a that corresponds to a tree as an identification target. The degree of a blur of the tree in the area 26a is just right for providing a certain variation in the identification target. With respect to data 27, similarly attention is directed to an area 27a that corresponds to a tree as an identification target. Since the degree of a blur of the tree in the area 27a is too coarse, there is almost no feature variation in the identification target. Accordingly, the generator 131 selects a parameter corresponding to the data 26 in the example illustrated in FIG. 7.

According to the process (2), an image as a target to which noise is to be added (training data), or an intermediate image output from an intermediate layer, is Fourier-transformed, and a parameter is established in order to provide a spatial variance corresponding to a peak frequency. For example, the process (2) establishes a parameter in order to eliminate frequency components higher than the peak frequency due to the Fourier-transform. The process (2) is effective for images in which there are patterns or textures. According to the process (2), in case a Gaussian filter is used, since the cutoff frequency f_{c} is indicated by the equation (3) illustrated below, σ may be set according to the equation (4) illustrated below. In the equation (3), Fₛ represents a sampling frequency.

f_{c}=Fₛ/2πσ (3)

σ=(height or width of the image)/2π (peak frequency) (4)

Next, the process (3) establishes a parameter of noise depending on a parameter of the convolutional layer, for example, the size of a filter or the size of a sliding window, used in the convolutional process. According to the process (3), a parameter of noise is established in order to provide noise that has a certain variation within a range to be processed by the filter.

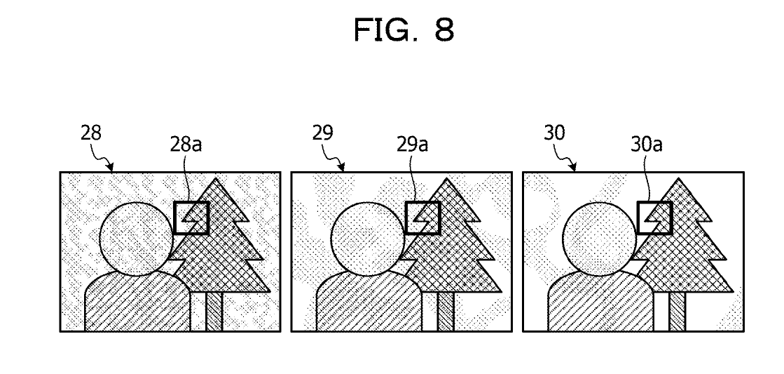

FIG. 8 is a diagram illustrating an example in which a parameter is selected depending on a size of a sliding window on a convolutional layer. FIG. 8 illustrates an example of the process (3). According to the process (3), if the type of a tree is to be recognized based on its shade, a parameter of noise is established in order to provide noise that has a certain variation within the range of the sliding window. With respect to data 28 illustrated in FIG. 8, attention is directed to a sliding window 28a. Since the degree of a blur is too detailed in the sliding window 28a, the feature of the noise in the sliding window 28a is learned. With respect to data 29, similarly attention is directed to a sliding window 29a. The degree of a blur in the sliding window 29a is just right for providing a certain variation in the convolutional filter. With respect to data 30, similarly attention is directed to a sliding window 30a. Since the degree of a blur too coarse in the sliding window 30a, the noise has essentially no effect in one convolutional process. Accordingly, the generator 131 establishes a parameter of noise corresponding to the data 29 in the example illustrated in FIG. 8. The sliding windows 28a through 30a represent a range to be processed by one convolutional process and have a size equal to filter size×filter size of the convolutional process.

The above processes (1) through (3) may be combined together. For example, around an input layer of the CNN, the processes (1) and (2) are used and attention is directed to the input data to establish the degree of a blur. In a deep layer of the CNN, attention is directed to the filter size of the convolutional layer to establish the degree of a blur. This is because in the deep layer, the image size is reduced by a pooling process, etc., making it difficult to add detailed noise, and also because it is not clear what amount of feature is produced for each element in the deep layer.

According to the process (4), parameter candidates relative to some blur degrees are made available, and are applied so that a parameter with the largest loss function is employed. The loss function refers to a loss function of a task, such as image recognition or object detection, for example. The process (4) is carried out for each learning iteration.

The value of the loss function with respect to training data suggests the following possibilities or tendencies depending on the magnitude thereof. If the value of the loss function is “extremely small,” there is a possibility of overfitting, for example, overadaptation to training data. If the value of the loss function is “small,” there is a tendency of overfitting though the learning process is in progress. If the value of the loss function is “large,” the learning process is progressing and overfitting is restrained. If the value of the loss function is “very large,” the learning process is not progressing. For assessing whether overfitting is really restrained or not, it may be required to see whether the value of the loss function with respect to validation data not included in training data is not large. The magnitude of the value of the loss function represents a tendency of the loss function as seen with respect to training data. The case where the value of the loss function is “large” includes a case where a parameter with the largest loss function is included in a plurality of parameter candidates for which data augmentation has been successful. If the value of the loss function is “very large,” the data augmentation has failed.

According to the process (4), therefore, an effect of restraining overfitting may be expected by selecting a parameter with the value of the loss function being large to a certain extent. For example, according to the process (4), since parameters with the value of the loss function being large to a certain extent are changed depending on the progress of the learning process, parameters are switched depending on the progress of the learning process. According to the process (4), therefore, noise that does not lend itself to NN may positively be added, possibly resulting in an increased generalization capability. In order to guarantee that parameters will be selected with the value of the loss function being “large” to a certain degree, rather than being “very large,” it is required to establish parameter candidates for the degree of a blur adequately by using the processes (1) through (3) or the like. Comparison of the process (4) with the processes (1) through (3) indicates that whereas a parameter for the degree of a blur is fixed in advance according to the processes (1) through (3), a parameter for the degree of a blur is set to appropriate values during learning from time to time depending on the progress of the learning process according to the process (4).

The generator 131 selects a noise adding process by selecting either one of the processes (1) through (4) or a combination of them. A noise adding process may be selected by the generator 131 depending on preset conditions, for example, the resolution and the number of layers of training data, the configuration of the CNN, and so on, or may be accepted from the user of the learning apparatus 100.

The generator 131 establishes parameters of the learners depending on the selected noise adding process. The generator 131 sets parameters about the convolutional layer, among the parameters of the learners, in the first learning section 132. The generator 131 sets parameters about the fully connected layers, among the parameters of the learners, in the second learning section 133. Furthermore, the generator 131 stores the established parameters in the parameter storage section 122. For example, the generator 131 generates augmented data by augmenting the training data according to the various parameters. After completing the establishment of the parameters, the generator 131 instructs the first learning section 132 to start a learning process.

For example, the generator 131 generates augmented data by data-augmenting at least some of the training data or at least some data of the data input to the convolutional layer included in the learners, using a filter having a size depending on the details of the processing of the convolutional layer. Moreover, the generator 131 generates augmented data by data-augmenting the data of the intermediate layers of the learners, using a filter. In addition, the generator 131 generates augmented data by data-augmenting the data of the input layers of the learners, using a filter. Furthermore, the generator 131 generates augmented data by Fourier-transforming data and augmenting the Fourier-transformed data by eliminating frequency components higher than the peak frequency. Moreover, the generator 131 generates augmented data by augmenting data by adding noise to the data to achieve the degree of a blur depending on the size of the sliding window of the convolutional layer. Additionally, the generator 131 generates augmented data by applying a parameter with the largest loss function among the plurality of parameters of the learners for which data augmentation has been successful, depending on the progress of the learning process. Furthermore, the generator 131 generates augmented data by augmenting at least some of the training data or at least some data of the data input to the convolutional layer, using a filter having a size depending on the size of an identification target for the learners.

Referring back to FIG. 1, the first learning section 132 is a convolutional layer learning section among the learners of the CNN. The first learning section 132 sets the parameter about the convolutional layer input from the generator 131 in the convolutional layer. When instructed to start a learning process by the generator 131, the first learning section 132 learns the training data by referring to the training data storage section 121. For example, the first learning section 132 learns the training data and the augmented data that have been augmented according to each of the parameters. When the learning of the convolutional layer is completed, the first learning section 132 outputs the data being learned to the second learning section 133.

The second learning section 133 is a fully connected layer learning section among the learners of the CNN. The second learning section 133 sets the parameter about the fully connected layer input from the generator 131 in the convolutional layer. When supplied with the data being learned from the first learning section 132, the second learning section 133 learns the data being learned. For example, the second learning section 133 learns the data being learned that have been data-augmented. When the learning of the fully connected layer is completed, the first learning section 132 and the second learning section 133 store a learning model in the learning model storage section 123. For example, the first learning section 132 and the second learning section 133 generate a learning model by learning the learners using the training data and the augmented data.

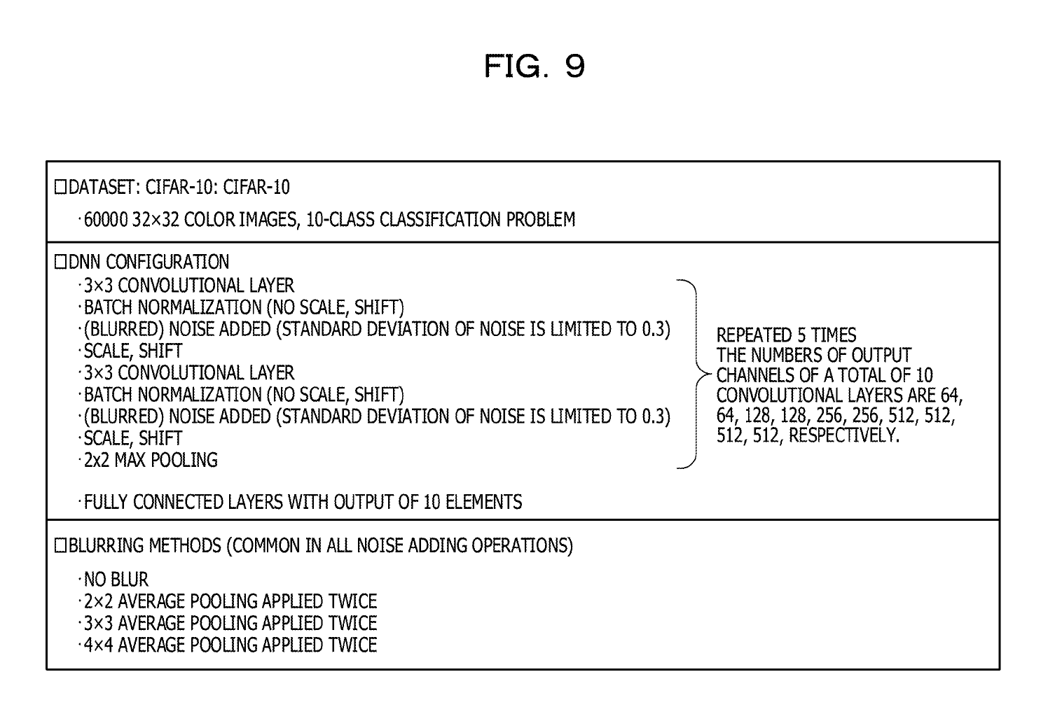

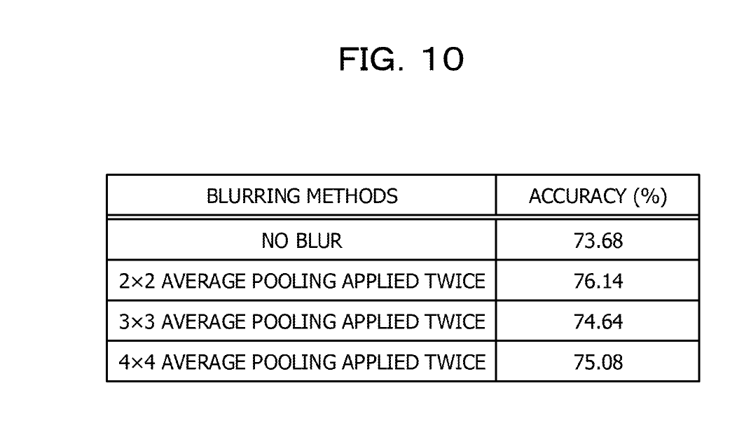

A dataset and parameters and the accuracies of test data about a specific example will be described below with reference to FIGS. 9 and 10. FIG. 9 is a diagram illustrating an example of parameters and so on in the specific example. The specific example illustrated in FIG. 9 uses CIFAR-10 as a dataset. CIFAR-10 contains 60000 RGB color images each of 32×32 pixels, and is a 10-class classification problem. The configuration of the DNN (CNN) corresponds to the above process (3). As illustrated in FIG. 9, there are four blurring methods (blur degrees) including “NO BLUR,”“2×2 AVERAGE POOLING APPLIED TWICE,” “3×3 AVERAGE POOLING APPLIED TWICE,” and “4×4 AVERAGE POOLING APPLIED TWICE.”

FIG. 10 is a diagram illustrating an example of accuracies with respect to test data after a learning process in the specific example. FIG. 10 illustrates accuracies of discrimination obtained when learning models corresponding to the respective four blurring methods illustrated in FIG. 9 are generated and test data were discriminated using each of the learning models in the learning apparatus 100. As illustrated in FIG. 10, higher accuracies were achieved when there were blurs than when there was no blur. It can also be seen that the different blurring methods resulted in different accuracies of discrimination. In FIGS. 9 and 10, the highest accuracy was achieved by “2×2 AVERAGE POOLING APPLIED TWICE.” In the specific example, “2×2 AVERAGE POOLING APPLIED TWICE” is well compatible with the dataset, task, and network configuration. In the DNN (CNN), the accuracy difference of 1% may be considered to be sufficiently large.

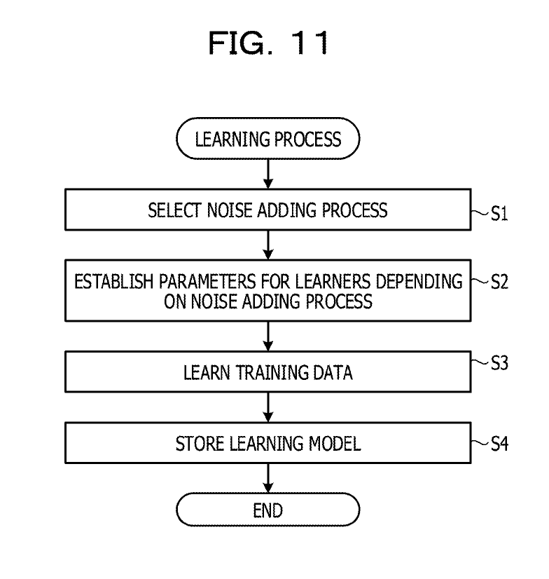

Next, operation of the learning apparatus 100 according to the embodiment will be described below. FIG. 11 is a flowchart illustrating an example of a learning process according to the embodiment.

The generator 131 receives and acquires training data for the learning process from another terminal, for example. The generator 131 stores the acquired training data in the training data storage section 121. The generator 131 selects a noise adding process based on the above processes (1) through (4) (step S1).

The generator 131 establishes parameters for the learners depending on the selected noise adding process (step S2). For example, the generator 131 sets parameters about the convolutional layer, among the parameters of the learners, in the first learning section 132, and sets parameters about the fully connected layers in the second learning section 133. Furthermore, the generator 131 stores the established parameters in the parameter storage section 122. After completing the establishment of the parameters, the generator 131 instructs the first learning section 132 to start a learning process.

The first learning section 132 and the second learning section 133 set therein each of the parameters input from the generator 131. When instructed to start a learning process by the generator 131, the first learning section 132 learns the training data by referring to the training data storage section 121 (step S3). When the learning of the convolutional layer is completed, the first learning section 132 outputs the data being learned to the second learning section 133. When supplied with the data being learned from the first learning section 132, the second learning section 133 learns the data being learned. When the learning of the fully connected layer is completed, the first learning section 132 and the second learning section 133 store a learning model in the learning model storage section 123 (step S4). The learning apparatus 100 is thus able to increase the accuracy of discrimination of the learners including the convolutional process. For example, the learning apparatus 100 may perform data augmentation that is not just a change in the entire input data on the convolutional layer of the DNN (CNN). The learning apparatus 100 may also add noise that does not adversely affect the learning process to the convolutional layer of the DNN (CNN). For example, the learning apparatus 100 is more effective to restrain overfitting.

As described above, the learning apparatus 100 uses learners including a convolutional layer. For example, the learning apparatus 100 generates augmented data by data-augmenting at least some of the training data or at least some data of the data input to the convolutional layer included in the learners, using a filter having a size depending on the details of the processing of the convolutional layer. Furthermore, the learning apparatus 100 learns the learners using the training data and the augmented data. As a result, the learning apparatus 100 is able to increase the accuracy of discrimination of the learners including the convolutional process.

Moreover, the learning apparatus 100 generates augmented data by data-augmenting the data of the intermediate layers of the learners, using a filter. As a result, the learning apparatus 100 is able to increase the accuracy of discrimination of the learners including the convolutional process.

In addition, the learning apparatus 100 generates augmented data by data-augmenting the data of the input layers of the learners, using a filter. As a result, the learning apparatus 100 is thus able to increase the accuracy of discrimination of the learners including the convolutional process.

Furthermore, the learning apparatus 100 generates augmented data by Fourier-transforming data and data-augmenting the Fourier-transformed data by eliminating frequency components higher than the peak frequency. As a result, the learning apparatus 100 is thus able to increase the accuracy of discrimination in case the recognition target has a pattern and a texture.

Moreover, the learning apparatus 100 generates augmented data by augmenting data by adding noise to the data to achieve the degree of a blur depending on the size of the sliding window of the convolutional layer. As a result, the learning apparatus 100 may augment data by adding noise to a deep layer in the convolutional layer.

Additionally, the learning apparatus 100 generates augmented data by applying a parameter with the largest loss function, among the plurality of parameters of the learners for which data augmentation has been successful, depending on the progress of the learning process. As a result, the learning apparatus 100 may increase the generalization capability of the learners.

Furthermore, the learning apparatus 100 uses the learners including the convolutional layer. For example, the learning apparatus 100 generates augmented data by data-augmenting at least some of the training data or at least some data of the data input to the convolutional layer, using a filter having a size depending on the size of an identification target for the learners. Furthermore, the learning apparatus 100 learns the learners using the training data and the augmented data. As a result, the learning apparatus 100 is able to increase the accuracy of discrimination of the learners including the convolutional process.

The neural network referred to in the above embodiment is of a multistage configuration including an input layer, an intermediate layer (hidden layer), and an output layer. Each of the layers has a configuration in which a plurality of nodes are coupled by edges. Each of the layers has a function called “activation function.” Each of the edges has a “weight.” The value of each of the nodes is calculated from the values of the nodes in the preceding layer, the values of the weights of the coupled edges, and the activation function of the layer. Any of various known methods may be employed to calculate the value of each of the nodes.

Each of the components of the various illustrated sections, units, and so on is not necessarily physically constructed as illustrated. The various sections, units, and so on are not limited to the distributed and integrated specific configurations that are illustrated, but may wholly or partly be functionally or physically distributed and integrated in any arbitrary chunks depending on various loads, usage circumstances, etc. For example, the first learning section 132 and the second learning section 133 may be integrated with each other. The illustrated processing steps are not limited to the above sequence, but may be carried out at the same time or may be switched around as long as the processing details do not contradict each other.

The various processing functions performed by the various devices and units may wholly or partly be performed by a CPU or a microcomputer such as an MPU, a micro controller unit (MCU), or the like. Furthermore, the various processing functions may wholly or partly be performed by programs interpreted and executed by a CPU or a microcomputer such as an MPU, an MCU, or the like, or wired-logic hardware.

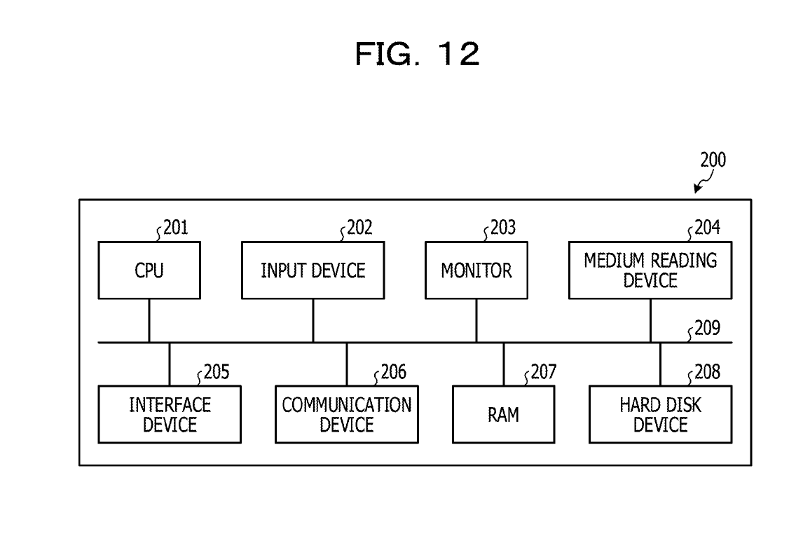

The various processing sequences described in the above embodiment may be carried out by a computer executing a given program. An example of computer that executes a program having the similar functions as those described in the above embodiment will be described below. FIG. 12 is a diagram illustrating an example of a computer that executes a machine learning program.

As illustrated in FIG. 12, a computer 200 includes a CPU 201 for performing various processing sequences, an input device 202 for accepting data inputs, and a monitor 203. The computer 200 also includes a medium reading device 204 for reading programs, etc. from a recording medium, an interface device 205 for coupling to various devices, and a communication device 206 for coupling to another information processing apparatus through a wired or wireless link. The computer 200 further includes a RAM 207 for temporarily storing various pieces of information and a hard disk device 208. The devices 201 through 208 are coupled to a bus 209.

The hard disk device 208 stores a machine learning program having the similar functions as those of each of the processing units including the generator 131, the first learning section 132, and the second learning section 133 illustrated in FIG. 1. The hard disk device 208 also stores therein the training data storage section 121, the parameter storage section 122, the learning model storage section 123, and various data for realizing the machine learning program. The input device 202 accepts various items of information such as operating information and so on from the administrator of the computer 200, for example. The monitor 203 display various screens such as display screens, etc. for the administrator of the computer 200 to see. To the interface device 205, there is coupled to a printing device or the like, for example. The communication device 206 has the same functions as those of the communication unit 110 illustrated in FIG. 1, and is coupled to a network, not illustrated, for exchanging various pieces of information with other information processing apparatus.

The CPU 201 reads various programs stored in the hard disk device 208, loads the read programs into the RAM 207, and executes the programs to perform various processing sequences. These programs enable the computer 200 to function as the generator 131, the first learning section 132, and the second learning section 133 illustrated in FIG. 1.

The machine learning program may not necessarily be stored in the hard disk device 208. The computer 200 may read programs stored in a storage medium that is readable by the computer 200 and execute the read programs, for example. The storage medium that is readable by the computer 200 may be a portable recording medium such as a compact disc-read-only memory (CD-ROM), a digital versatile disc (DVD), a universal serial bus (USB) memory, or the like, or a semiconductor memory such as a flash memory or the like, or a hard disk drive, or the like. Alternatively, a device coupled to a public network, the Internet, a local area network (LAN), or the like may store the machine learning program, and the computer 200 may read the machine learning program from the device and execute the read machine learning program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium with a machine learning program recorded therein for enabling a computer to perform processing, comprising:
generating augmented data by data-augmenting at least some data of training data or at least some data of data input to a convolutional layer included in a learner, using a filter corresponding to a size depending on details of the processing of the convolutional layer or a filter corresponding to a size of an identification target for the learner; and
learning the learner using the training data and the augmented data.

2. The non-transitory computer-readable recording medium according to claim 1, wherein
the generating augmented data includes generating the augmented data by data-augmenting data of an intermediate layer of the learner using the filter.

3. The non-transitory computer-readable recording medium according to claim 1, wherein
the generating augmented data includes generating the augmented data by data-augmenting data of an input layer of the learner using the filter.

4. The non-transitory computer-readable recording medium according to claim 1, wherein
the generating augmented data includes generating the augmented data by Fourier-transforming the data and data-augmenting the Fourier-transformed data by eliminating frequency components higher than a peak frequency.

5. The non-transitory computer-readable recording medium according to claim 1, wherein
the generating augmented data includes generating the augmented data by augmenting the data by adding noise to the data, the noise to achieve a degree of a blur depending on a size of a sliding window of the convolutional layer.

6. The non-transitory computer-readable recording medium according to claim 1, wherein
the generating augmented data includes generating the augmented data by applying a parameter with the largest value of a loss function from among a plurality of parameters of the learner for which data augmentation has been successful, depending on the progress of a learning process of the learner.

7. A machine learning method comprising:
generating, by a computer, augmented data by data-augmenting at least some data of training data or at least some data of data input to a convolutional layer included in a learner, using a filter corresponding to a size depending on details of the processing of the convolutional layer or a filter corresponding to a size of an identification target for the learner; and
learning the learner using the training data and the augmented data.

8. The machine learning method according to claim 7, wherein
the generating augmented data includes generating the augmented data by data-augmenting data of an intermediate layer of the learner using the filter.

9. The machine learning method according to claim 7, wherein
the generating augmented data includes generating the augmented data by data-augmenting data of an input layer of the learner using the filter.

10. The machine learning method according to claim 7, wherein
the generating augmented data includes generating the augmented data by Fourier-transforming the data and data-augmenting the Fourier-transformed data by eliminating frequency components higher than a peak frequency.

11. The machine learning method according to claim 7, wherein
the generating augmented data includes generating the augmented data by augmenting the data by adding noise to the data, the noise to achieve a degree of a blur depending on a size of a sliding window of the convolutional layer.

12. The machine learning method according to claim 7, wherein
the generating augmented data includes generating the augmented data by applying a parameter with the largest value of a loss function from among a plurality of parameters of the learner for which data augmentation has been successful, depending on the progress of a learning process of the learner.

13. An information processing apparatus comprising:
a memory; and
a processor coupled to the memory and configured to execute a processing of:
generating augmented data by data-augmenting at least some data of training data or at least some data of data input to a convolutional layer included in a learner, using a filter corresponding to a size depending on details of the processing of the convolutional layer or a filter corresponding to a size of an identification target for the learner; and
learning the learner using the training data and the augmented data.

14. The information processing apparatus according to claim 13, wherein
the generating augmented data includes generating the augmented data by data-augmenting data of an intermediate layer of the learner using the filter.

15. The information processing apparatus according to claim 13, wherein
the generating augmented data includes generating the augmented data by data-augmenting data of an input layer of the learner using the filter.

16. The information processing apparatus according to claim 13, wherein
the generating augmented data includes generating the augmented data by Fourier-transforming the data and data-augmenting the Fourier-transformed data by eliminating frequency components higher than a peak frequency.

17. The information processing apparatus according to claim 13, wherein
the generating augmented data includes generating the augmented data by augmenting the data by adding noise to the data, the noise to achieve a degree of a blur depending on a size of a sliding window of the convolutional layer.

18. The information processing apparatus according to claim 13, wherein
the generating augmented data includes generating the augmented data by applying a parameter with the largest value of a loss function from among a plurality of parameters of the learner for which data augmentation has been successful, depending on the progress of a learning process of the learner.
